(19) United States
(12) Patent Application Publication
(10) Pub. No.: US 2025/0218676 A1
(43) Pub. Date: Jul. 3, 2025

(54) MULTILAYER ELECTRONIC COMPONENT

(71) Applicant: SAMSUNG ELECTRO-MECHANICS CO., LTD., Suwon-si (KR)

(72) Inventors: Sang Woo KIM, Suwon-si (KR); Hye Sung YOON, Suwon-si (KR); Hwa Young LEE, Suwon-si (KR); San KYEONG, Suwon-si (KR); Seol Ah CHONG, Suwon-si (KR)

(73) Assignee: SAMSUNG ELECTRO-MECHANICS CO., LTD., Suwon-si (KR)

(21) Appl. No.: 18/951,982

(22) Filed: Nov. 19, 2024

(30) Foreign Application Priority Data
Dec. 29, 2023 (KR) 10-2023-0197038

(51) Int. Cl. H01G 4/12; H01G 4/30

(52) U.S. Cl. CPC H01G 4/1227; H01G 4/30

(57) ABSTRACT

A multilayer electronic component includes a body including a capacitance formation portion including a dielectric layer and internal electrodes alternately disposed with the dielectric layer in a first direction, and cover portions disposed in upper and lower portions in the first direction of the capacitance formation portion, respectively, and including first and second surfaces opposing each other in the first direction; external electrodes disposed on the body. One of the cover portions includes one or more crystal phases having an oxide including a rare earth element and Si. When an area ratio occupied by the crystal phase in a central portion of one of the first and second surfaces is defined as S1, and an area ratio occupied by the crystal phase in a central portion of a cross-section in the first and third directions of the one of the cover portions is defined as S2, S1>S2 is satisfied.

### CROSS-REFERENCE TO RELATED APPLICATION(S)

The application claims benefit of priority to Korean Patent Application No. 10-2023-0197038 filed on Dec. 29, 2023 in the Korean Intellectual Property Office, the disclosure of which is incorporated herein by reference in its entirety.

### BACKGROUND

### 1. Field

The present disclosure relates to a multilayer electronic component.

### 2. Description of Related Art

A multilayer ceramic component (MLCC), a multilayer electronic component, may be a chip condenser mounted on the printed circuit boards of various electronic products including image display devices such as a liquid crystal display (LCD) and a plasma display panel (PDP), a computer, a smartphone, a mobile phone, or the like, and charging or discharging electricity therein or therefrom.

Such a multilayer ceramic capacitor may be used as a component of various electronic devices, since a multilayer ceramic capacitor may have a small size and high capacitance and may be easily mounted. As electronic devices such as computers and mobile devices have been designed to have a reduced size and a higher output, demand for miniaturization and higher capacitance of a multilayer ceramic capacitor has been increased.

Also, as application to automotive electrical components increases, high reliability in various environments has been necessary. In particular, since a power train, which is a core component of an automobile, may generate heat of over 100° C., the development of a multilayer ceramic capacitor operating stably even at high temperature has been necessary.

To improve high-temperature reliability of a multilayer ceramic capacitor, a material of a dielectric layer may be changed. For example, dielectric crystal grains may be configured to have a core-shell structure. However, since a shape of a core-shell structure may greatly affect electrical properties of a multilayer ceramic capacitor, it may be difficult to control a microstructure.

### SUMMARY

An embodiment of the present disclosure is to provide a multilayer electronic component having improved reliability.

An embodiment of the present disclosure is to provide a multilayer electronic component having improved high-temperature reliability.

According to an embodiment of the present disclosure, a multilayer electronic component includes a body including a capacitance formation portion including a dielectric layer and internal electrodes alternately disposed with the dielectric layer in a first direction, and cover portions disposed in upper and lower portions in the first direction of the capacitance formation portion, respectively, and including first and second surfaces opposing each other in the first direction, the third and fourth surfaces connected to the first and second surfaces and connected to each other in a second direction, and fifth and sixth surfaces connected to the first to fourth surfaces and opposing each other in a third direction; external electrodes disposed on the body. One of the cover portions includes one or more crystal phases formed of an oxide including a rare earth element and Si. When an area ratio occupied by the crystal phase in a central portion of one of the first and second surfaces is defined as S1, and an area ratio occupied by the crystal phase in a central portion of a cross-section in the first and third directions of the one of the cover portions is defined as S2, S1>S2 is satisfied. The one of the first and second surfaces is an exterior surface of the one of the cover portions.

### BRIEF DESCRIPTION OF DRAWINGS

The above and other aspects, features, and advantages of the present disclosure will be more clearly understood from the following detailed description, taken in combination with the accompanying drawings, in which:

FIG. 1 is a perspective diagram illustrating a multilayer electronic component according to an embodiment of the present disclosure;

FIG. 2 is a cross-sectional diagram taken along line I-I′ in FIG. 1;

FIG. 3 is a cross-sectional diagram taken along line II-II′ in FIG. 1;

FIG. 4 is an exploded diagram illustrating a body in FIG. 1 according to an embodiment of the present disclosure;

FIG. 5 is a scanned image of K1 in FIG. 1 using a scanning electron microscope;

FIG. 6 is a scanned image of K2 in FIG. 3 using a scanning electron microscope;

FIG. 7 is a diagram illustrating a shape of a crystal phase according to an embodiment of the present disclosure; and

FIG. 8 is a diagram illustrating a scanned image of a surface of a cover portion of a comparative example using a scanning electron microscope.

### DETAILED DESCRIPTION

Hereinafter, embodiments of the present disclosure will be described as below with reference to the accompanying drawings.

These embodiments are described in sufficient detail to enable those skilled in the art to practice the invention. It is to be understood that the various embodiments of the invention, although different, are not necessarily mutually exclusive. For example, structures, shapes, and sizes described as examples in embodiments in the present disclosure may be implemented in another embodiment without departing from the spirit and scope of the present disclosure. Further, modifications of positions or arrangements of elements in embodiments may be made without departing from the spirit and scope of the present disclosure. The following detailed description is, accordingly, not to be taken in a limiting sense, and the scope of the present invention is defined only by appended claims, appropriately interpreted, along with the full range of equivalents to which the claims are entitled.

In the drawings, same elements will be indicated by same reference numerals. Also, redundant descriptions and detailed descriptions of known functions and elements which may unnecessarily make the gist of the present disclosure obscure will be omitted. In the accompanying drawings, some elements may be exaggerated, omitted or briefly illustrated, and the sizes of the elements do not necessarily reflect the actual sizes of these elements. The terms, “include,” “comprise,” “is configured to,” or the like of the description are used to indicate the presence of features, numbers, steps, operations, elements, portions or combination thereof, and do not exclude the possibilities of combination or addition of one or more features, numbers, steps, operations, elements, portions or combination thereof.

In the drawings, the first direction may be defined as a thickness (T) direction, the second direction may be defined as a length (L) direction, and the third direction may be defined as a width (W) direction.

### Multilayer Electronic Component

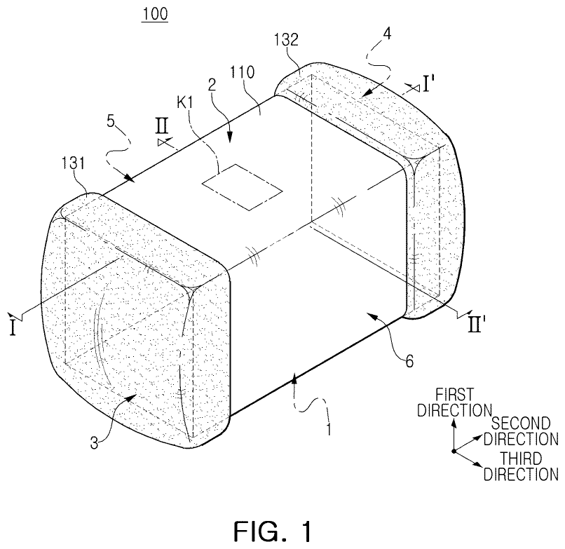

FIG. 1 is a perspective diagram illustrating a multilayer electronic component according to an embodiment.

FIG. 2 is a cross-sectional diagram taken along line I-I′ in FIG. 1.

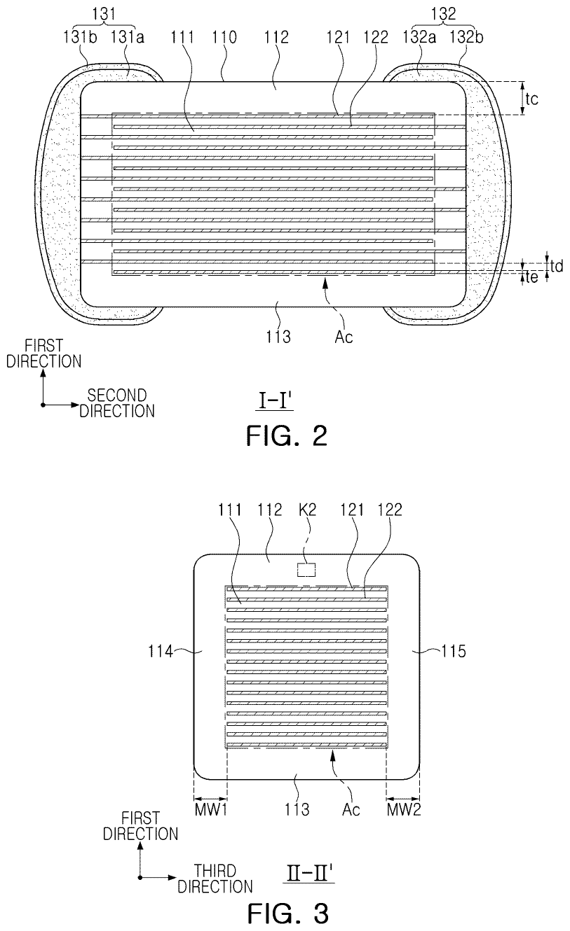

FIG. 3 is a cross-sectional diagram taken along line II-II′ in FIG. 1.

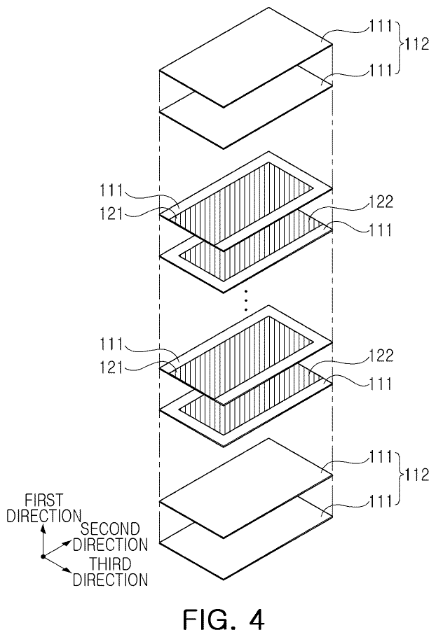

FIG. 4 is an exploded diagram illustrating a body in FIG. 1 according to an embodiment.

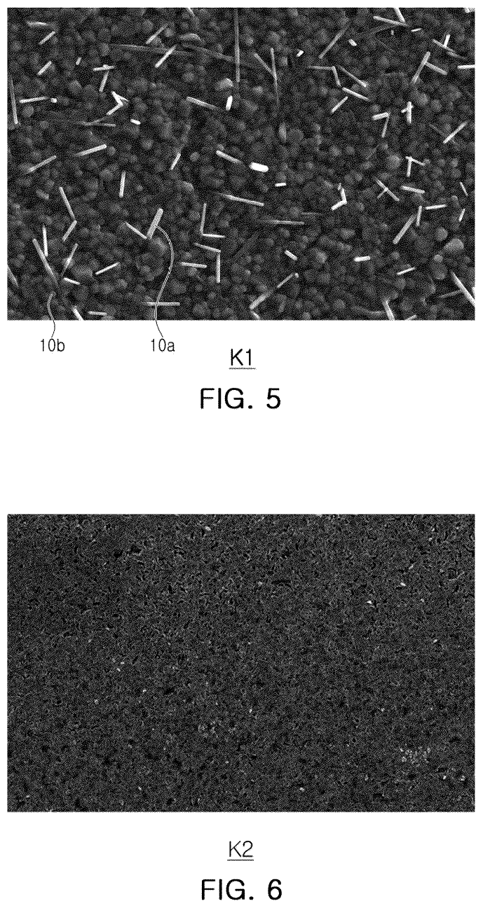

FIG. 5 is a scanned image of K1 in FIG. 1 using a scanning electron microscope.

FIG. 6 is a scanned image of K2 in FIG. 3 using a scanning electron microscope.

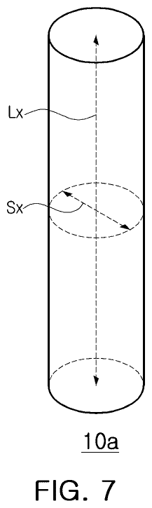

FIG. 7 is a diagram illustrating a shape of a crystal phase according to an embodiment.

Hereinafter, a multilayer electronic component 100 according to an embodiment will be described in greater detail with reference to FIGS. 1 to 7. A multilayer ceramic capacitor will be described as an example of a multilayer electronic component (hereinafter, multilayer ceramic capacitor, MLCC), but an embodiment thereof is not limited thereto, and the multilayer ceramic capacitor may be applied to various multilayer electronic components, such as an inductor, a piezoelectric element, a varistor, or a thermistor.

The multilayer electronic component 100 may include a body 110 including a capacitance formation portion Ac including a dielectric layer 111 and internal electrodes 121 and 122 alternately disposed with the dielectric layer 111 in a first direction, and cover portion 112 and 113 disposed in upper and lower portions in the first direction of the capacitance formation portion Ac, and including first and second surfaces 1 and 2 opposing each other in the first direction, the third and fourth surfaces 3 and 4 connected to the first and second surfaces 1 and 2 and connected to each other in a second direction, and fifth and sixth surfaces 5, 6 connected to the first to fourth surfaces 1 to 4 and opposing each other in a third direction, and external electrodes 131 and 132 disposed on the body 110. The cover portion may include one or more crystal phases formed of an oxide including a rare earth element and Si. When an area ratio occupied by the crystal phase in a central portion of the first and second surfaces is defined as S1, and an area ratio occupied by the crystal phase in the central portion of a cross-section in the first and third directions of the cover portion is defined as S2, S1>S2 may be satisfied.

According to an embodiment, by disposing the crystal phase 10a formed of an oxide including a rare earth element and Si on the surface of the cover portion 112 and 113, thermal conductivity may be lowered and heat absorption from the outside may be reduced, thereby improving high-temperature reliability. Also, the crystal phase 10a formed of an oxide including a rare earth element and Si may have a relatively low coefficient of thermal expansion, such that cracks in the body 110 may be prevented, and a moisture absorption rate may be lowered, thereby improving moisture resistance reliability.

Hereinafter, each component included in the multilayer electronic component 100 according to an embodiment will be described.

In the body 110, the dielectric layers 111 and the internal electrodes 121 and 122 may be alternately laminated.

The shape of the body 110 may not be limited to any particular shape, but as illustrated, the body 110 may have a hexahedral shape or a shape similar to a hexahedral shape. Due to reduction of ceramic powder included in the body 110 during a firing process or polishing of corners, the body 110 may not have an exactly hexahedral shape formed by linear lines but may have a substantially hexahedral shape.

The body 110 may have the first and second surfaces 1 and 2 opposing each other in the first direction, the third and fourth surfaces 3 and 4 connected to the first and second surfaces 1 and 2 and opposing in the second direction, and the fifth and sixth surfaces 5 and 6 connected to the first and second surfaces 1 and 2 and the third and fourth surfaces 3 and 4 and opposing each other in the third direction.

Since the margin region in which the internal electrodes 121 and 122 are not disposed overlaps the dielectric layer 111, a step difference may be formed due to the thickness of the internal electrodes 121 and 122, and a corner connecting the first surface 1 to the third to fifth surfaces 3, 4, and 5 and/or a corner connecting the second surface 2 to the third to fifth surfaces 3, 4, and 5 may have a reduced shape toward the center in first direction of the body 110 when viewed from the first surface 1 or the second surface 2. Alternatively, due to shrinkage behavior during the sintering process of the body 110, a corner connecting the first surface 1 to the third to sixth surfaces 3, 4, 5, and 6 and/or a corner connecting the second surface 2 to the third to sixth surfaces 3, 4, 5, and 6 may have a reduced shape toward the center in the first direction of the body 110 when viewed from the first surface 1 or the second surface 2. Alternatively, to prevent chipping defects, the corners connecting the surfaces of the body 110 may be rounded by performing a specific process to round the corners, such that each of the corners connecting the first surface 1 to the third to sixth surfaces 3, 4, 5, and 6 and/or the corners connecting the second surface 2 to the third to sixth surfaces 3, 4, 5, and 6 may have a rounded shape.

To suppress the step difference formed by the internal electrodes 121 and 122, when the internal electrodes are cut out to be exposed to the fifth and sixth surfaces 5 and 6 of the body after lamination, a dielectric layer or two or more dielectric layers are laminated in the third direction (width direction) on both side surfaces of the capacitance formation portion Ac to form the margin portions 114 and 115, the portion connecting the first surface 1 to the fifth and sixth surfaces 5 and 6 and the portion connecting the second surface 2 to the fifth and sixth surfaces 5 and 6 may not have a reduced shape.

The plurality of dielectric layers 111 forming the body 110 may be in a fired state, and boundaries between adjacent dielectric layers 111 may be integrated with each other such that boundaries therebetween may not be distinct without using a scanning electron microscope (SEM). It may not be necessary to specifically limit the number of laminates of the dielectric layer, and the number of laminates may be determined by considering the size of the multilayer electronic component. For example, the body 110 may be formed by laminating 400 or more layers of the dielectric layer 111.

The dielectric layer 111 may be formed by preparing a ceramic slurry including ceramic powder, an organic solvent, an additive, and a binder, preparing a ceramic green sheet by coating the slurry on a carrier film drying the slurry, and firing the ceramic green sheet. The ceramic powder is not limited to any particular example as long as sufficient electrostatic capacitance may be obtained. For example, powder based on barium titanate (BaTiO₃) and paraelectric powders based on CaZrO₃ can be used as ceramic powder. The ceramic powder may be one or more of BaTiO₃, (Ba₁₋ₓCaₓ)TiO₃ (0<x<1), Ba(Ti_{1-y}Ca_{y})O₃ (0<y<1), (Ba₁₋ₓCaₓ)(Ti_{1-y}Zr_{y})O₃ (0<x<1, 0<y<1) and Ba(Ti_{1-y}Zr_{y})O₃ (0<y<1). The paraelectric powder based on CaZrO₃ may be (Ca₁₋ₓSrₓ)(Zr_{1-y}Ti_{y})O₃ (0<x<1, 0<y<1).

Accordingly, the dielectric layer 111 may include one or more of BaTiO₃, (Ba₁₋ₓCaₓ)TiO₃ (0<x<1), Ba(Ti_{1-y}Ca_{y})O₃ (0<y<1), (Ba₁₋ₓCaₓ)(Ti_{1-y}Zr_{y})O₃ (0<x<1, 0<y<1), Ba(Ti_{1-y}Zr_{y})O₃ (0<y<1) and (Ca₁₋ₓSrₓ)(Zr_{1-y}Ti_{y})O₃ (0<x<1, 0<y<1). In an embodiment, the dielectric layer 111 may include (Ca₁₋ₓSrₓ)(Zr_{1-y}Ti_{y})O₃ (0<x<1, 0<y<1) as a main component.

The body 110 may include a capacitance forming portion Ac forming capacitance including the first internal electrode 121 and the second internal electrode 122 disposed in the body 110 and opposing each other with the dielectric layer 111 therebetween, and cover portions 112 and 113 formed in upper and lower portions of the capacitance forming portion Ac in the first direction.

Also, the capacitance forming portion Ac may contribute to forming the capacitance of the capacitor, and may be formed by repeatedly laminating the plurality of first and second internal electrodes 121 and 122 with the dielectric layer 111 interposed therebetween.

The internal electrodes 121 and 122 may include first and second internal electrodes 121 and 122. The first and second internal electrodes 121 and 122 may be alternately disposed to oppose each other with the dielectric layer 111 included in the body 110 therebetween, and may be exposed to the third and fourth surfaces 3 and 4 of the body 110, respectively.

The first internal electrode 121 may be spaced apart from the fourth surface 4 and may be exposed through the third surface 3, and the second internal electrode 122 may be spaced apart from the third surface 3 and may be exposed through the fourth surface 4. The first external electrode 131 may be disposed on the third surface 3 of the body 110 and may be connected to the first internal electrode 121, and the second external electrode 132 may be disposed on the fourth surface 4 of the body 110 and may be connected to the second internal electrode 122.

That is, the first internal electrode 121 may not be connected to the second external electrode 132 and may be connected to the first external electrode 131, and the second internal electrode 122 may not be connected to the first external electrode 131 and may be connected to the second external electrode 132. Accordingly, the first internal electrode 121 may be spaced apart from the fourth surface 4 at a predetermined distance, and the second internal electrode 122 may be spaced apart from the third surface 3 by a predetermined distance. Also, the first and second internal electrodes 121 and 122 may be spaced apart from the fifth and sixth surfaces of the body 110.

A conductive metal included in the internal electrodes 121 and 122 may be one or more of Ni, Cu, Pd, Ag, Au, Pt, In, Sn, Al, Ti and alloys thereof, but an embodiment thereof is not limited thereto.

The average thickness td of the dielectric layer 111 may not be limited to any particular example, and may be, for example, 0.1 μm to 10 μm. The average thickness te of the internal electrodes 121 and 122 may not be limited to any particular example, and may be, for example, 0.05 μm to 3.0 μm. Also, the average thickness td of the dielectric layer 111 and the average thickness te of the internal electrodes 121 and 122 may be arbitrarily determined according to desired properties or applications. For example, in the case of a miniature IT electronic component, to implement miniaturization and high capacitance, the average thickness td of the dielectric layer 111 may be 0.4 μm or less, and the average thickness te of the internal electrodes 121 and 122 may be 0.4 μm or less.

The average thickness td of the dielectric layer 111 and the average thickness te of the internal electrodes 121 and 122 may indicate the sizes of the dielectric layer 111 and the internal electrodes 121 and 122 in the first direction, respectively. The average thickness td of the dielectric layer 111 and the average thickness te of the internal electrodes 121 and 122 may be measured by scanning the cross-sections of the body 110 in the first and second directions using a scanning electron microscope (SEM) at 10,000 magnification. More specifically, the average thickness of the dielectric layer 111 may be measured by measuring the thickness at multiple points of the dielectric layer 111, for example, 30 points at equal distances in the second direction. Also, the average thickness of the internal electrodes 121 and 122 may be measured by measuring the thickness at multiple points of one of the internal electrodes 121 and 122, for example, 30 points at an equal distance in the second direction. The 30 points at equal distance may be designated in the capacitance forming portion. Meanwhile, by measuring the average value on 10 dielectric layers 111 and 10 internal electrodes 121 and 122, and the average thickness of the dielectric layer 111 and the average thickness of the internal electrodes 121 and 122 may be further generalized.

The cover portions 112 and 113 may include an upper cover portion 112 disposed on the capacitance forming portion Ac in the first direction and a lower cover portion 113 disposed in a lower portion of the capacitance forming portion Ac in the first direction.

The upper cover portion 112 and the lower cover portion 113 may be formed by laminating a single dielectric layer or two or more dielectric layers on the upper and lower surfaces of the capacitance forming portion Ac in the thickness direction, respectively, and may basically prevent damages to the internal electrode due to physical or chemical stress.

The cover portions 112 and 113 may include one or more crystal phases 10a formed of an oxide including a rare earth element and Si. The upper surface in the first direction of the upper cover portion 112 may form a second surface of the body 110, and the lower surface in the first direction of the lower cover portion 113 may form a first surface of the body 110. That is, the second surface 2 may be the upper surface in the first direction of the upper cover portion 112, and the first surface 1 may be the lower surface in the first direction of the lower cover portion 113.

According to an embodiment, when the area ratio occupied by the crystal phase in the central portion K1 of the first and second surfaces 1 and 2 is defined as S1, and the area ratio occupied by the crystal phase in the central portion K2 of the cross-section in the first and third directions of the cover portions 112 and 113 is defined as S2, S1>S2 may be satisfied.

Since the crystal phase 10a is formed of an oxide including a rare earth element and Si, the crystal phase 10a may have properties of low thermal conductivity, thermal expansion, and moisture absorption.

However, when the crystal phase 10a is disposed in the cover portion, the crystal phase 10a may affect electrical properties of the multilayer electronic component 100. Accordingly, according to an embodiment, by increasing the area ratio S1 occupied by the crystal phase 10a in the central portion K1 of the first and second surfaces 1 and 2 further than the area ratio S2 occupied by the crystal phase 10a in the central portion K2 of the cross-section in the first and third directions of the cover portion 112 and 113, influence on electrical properties of the multilayer electronic component 100 may be reduced and reliability may improve.

The rare earth element included in the crystal phase 10a may include one or more of Y, Dy, Ho, Er, Gd, Ce, Nd, Sm, Tb, Tm, La, Gd and Yb.

In an embodiment, the rare earth element included in the crystal phase 10a may be yttrium (Y). When the rare earth element included in the crystal phase 10a is yttrium (Y), thermal conductivity, thermal expansion, and low moisture absorption properties of the crystal phase 10a may be improved. Also, when the rare earth element included in the crystal phase 10a is yttrium (Y), the crystal phase 10a may be easily grown in a process of sintering the body 110 rather than separately adding the crystal phase 10a, such that the crystal phase 10a may be formed without a specific process.

In an embodiment, the crystal phase 10a may be Y₂Si₂O₇.

Y₂Si₂O₇ may have lower thermal conductivity and coefficient of thermal expansion than BaTiO₃, which may be advantageous for high-temperature reliability and prevention of cracking. The thermal conductivity of Y₂Si₂O₇ may be about 1.4 W/mK, and the coefficient of thermal expansion may be about 4 ppm/K. The thermal conductivity of BaTiO₃ may be about 2.8 W/mK, and the coefficient of thermal expansion may be about 10 ppm/K.

Referring to FIG. 7, in an embodiment, a ratio of a long axis Lx to a short axis Sx (Lx/Sx) of the crystal phase 10a may be 1.5 or more and 60 or less. That is, the crystal phase 10a may have a rod shape. Accordingly, thermal conductivity may be effectively reduced and heat absorption from the outside may be reduced.

It may not be necessary for the entirety of the crystal phases 10a included in the cover portions 112 and 113 to satisfy the above conditions, and a ratio of the long axis Lx to the short axis Sx (Lx/Sx) of one or more crystal phases 10a may satisfy 1.5 or more and 60 or less, but an example embodiment thereof is not limited thereto.

In an embodiment, a length of the short axis Sx of the crystal phase 10a may be 0.05 μm or more 0.5 μm or less, and a length of the long axis Lx may be 0.1 μm or more 3.0 μm or less.

It may not be necessary for the entirety of the crystal phases 10a included in the cover portions 112 and 113 to satisfy the above conditions, and a length of the short axis Sx of one or more crystal phases 10a may be 0.05 μm or more 0.5 μm or less, and a length of the long axis Lx may be 0.1 μm or more 3.0 μm or less, but an example embodiment thereof is not limited thereto.

In an embodiment, the area ratio S1 occupied by the crystal phase 10a in the central portion K1 of the first and second surfaces 1 and 2 may be 5% or more. As S1 is 5% or more, the effect of lowering thermal conductivity and reducing the heat absorption from the outside may be improved.

In an embodiment, the area ratio S1 occupied by the crystal phase 10a in the central portion K1 of the first and second surfaces 1 and 2 may be 5% or more 50% or less, and the area ratio S2 occupied by the crystal phase 10a in the central portion K2 of the cross-section in the first and third directions of the cover portions 112 and 113 may be 0% or more 0.1% or less.

Also, S2 may be 0%, and accordingly, the effect on electrical properties of the multilayer electronic component 100 may be reduced.

In an embodiment, the crystal phase 10a may have a cross-sectional area of 1.0 μm² or more, and may be disposed at 0.25/μm² or more and 2.0/μm² or less on the first and second surfaces. Accordingly, the effect of lowering thermal conductivity and reducing heat absorption from the outside may be further improved.

Also, the crystal phase 10a may have a cross-sectional area of 1.0 μm² or more, and may be disposed at 0.25 to 2.0 per μm² on the first and second surfaces, and at 0.01 to 0.01 per μm² in the cross-section of the cover portion in the first and third directions. That is, the crystal phase 10a having a cross-sectional area of 1.0 μm² or more may be disposed at 0.25 to 2.0 per unit area (μm²) on the first and second surfaces, and at 0.01 to 0.01 per unit area (μm²) in the cross-section in the first and third directions of the cover portion.

The method of measuring the area ratio and the number per unit area (μm²) of the crystal phase 10a is not limited to any particular example. For example, when the second surface is divided into three portions in the second direction and third direction, the region disposed in the center and the upper cover portion 112 may be measured by analyzing the cross-section in the first and third directions cut from the center in the second direction, and the region disposed in the center when divided into thirds in the first and third directions may be measured by analyzing the region using a scanning electron microscope (SEM).

FIG. 5 is a scanned image of K1 in FIG. 1 using a scanning electron microscope. Referring to FIG. 5, a plurality of rod-shaped crystal phase 10a may be disposed. Also, the phase may be clearly distinct from dielectric crystal grains 10b in the image by the difference in brightness. Accordingly, the area ratio and the number per unit area (μm²) of the crystal phase 10a may be measured by the difference in brightness using an image analysis program. For a more accurate analysis, the area ratio and the number per unit area of crystal phase 10a may be measured by analyzing the scanned image using SEM-EDS. The area ratio of crystal phase 10a may be the ratio of the area occupied by the crystal phase 10a to the area of the entire region of the scanned image, and the area ratio of the crystal phase 10a and the number per unit area (μm²) may be measured in a 10 μm×10 μm region.

The cover portions 112 and 113 may include a plurality of dielectric crystal grains 10b, and the crystal phase 10a may be disposed on the dielectric crystal grains 10b on the first and second surfaces. Referring to FIG. 5, the crystal phase 10a may be disposed on a plurality of dielectric crystal grains 10b, and a portion of the crystal phase 10a may be disposed at the grain boundary between the dielectric crystal grains 10b.

In an embodiment, the cover portions 112 and 113 may include one or more of BaTiO₃, (Ba₁₋ₓCaₓ)TiO₃ (0<x<1), Ba(Ti_{1-y}Ca_{y})O₃ (0<y<1), (Ba₁₋ₓCaₓ)(Ti_{1-y}Zr_{y})O₃ (0<x<1, 0<y<1) and Ba(Ti_{1-y}Zr_{y})O₃ (0<y<1) as a main component.

In an embodiment, the crystal phase 10a may not include Ba and Ti. Since the crystal phase 10a does not include Ba and Ti, it may be easy to distinct the phase from the dielectric crystal grains 10b.

In an embodiment, the cover portions 112 and 113 may include Ba, Ti, Y, Mn and Mg, and the crystal phase 10b may not include Ba and Ti.

The cover portion may include one or more of BaTiO₃, (Ba₁₋ₓCaₓ)TiO₃ (0<x<1), Ba(Ti_{1-y}Ca_{y})O₃ (0<y<1), (Ba₁₋ₓCaₓ)(Ti_{1-y}Zr_{y})O₃ (0<x<1, 0<y<1) and Ba(Ti_{1-y}Zr_{y})O₃ (0<y<1) as a main component, and may include 3 moles or more of Y based on 100 moles of Ti. Accordingly, the crystal phase 10b may be easily formed in the sintering process.

To confirm that the crystal phase may be easily formed when Y is 3 moles or more based on 100 moles of Ti, ceramic slurry for a cover portion was prepared by adding barium titanate (BaTiO₃) ceramic powder as a main component, yttrium oxide (Y₂O₃), silicon oxide (SiO₂), manganese oxide (Mn₃O₄), and magnesium carbonate (MgCO₃) as sub-components, adding organic solvents and binders, applying slurry on a carrier film and drying the slurry.

After laminating the ceramic green sheet for the cover portion, a ceramic green sheet having an internal electrode pattern printed thereon was laminated, and the ceramic green sheet for the cover portion was laminated, thereby preparing a laminate. Thereafter, the laminate was calcined at 400° C. for 12 hours, and secondary calcination was performed at 850° C. for 4 hours in an inert gas atmosphere. Thereafter, a sintering process was performed at 1,200° C. for 2 hours in a reducing atmosphere, thereby obtaining a body.

The ceramic green sheet for the cover portion of the comparative example was manufactured such that the contents of the sub-components Y, Si, Mn, and Mg were 1 mole, 2 moles, 0.15 mole, and 0.5 mole, respectively, based on 100 moles of Ti, and the ceramic green sheet for the cover portion of the inventive example was manufactured such that the contents of the sub-components Y, Si, Mn, and Mg were 3 moles, 2 moles, 0.15 mole, and 0.5 mole, respectively, based on 100 moles of Ti.

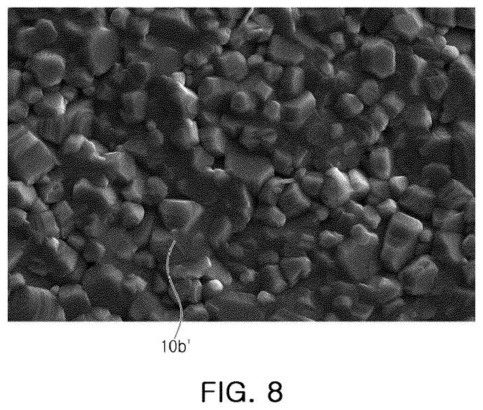

FIG. 6 is a scanned image of K2 in FIG. 3 using a scanning electron microscope. FIG. 8 is a diagram illustrating a scanned image of a surface of a cover portion of a comparative example using a scanning electron microscope. Referring to FIG. 6, in the case of the inventive example, the crystal phase 10a disposed on the dielectric crystal grains 10b was observed, but in the case of the comparative example, only the dielectric crystal grains 10b′ were observed and the crystal phase was not observed.

The cover portion 112 and 113 may not include the internal electrodes 121 and 122. However, to improve warpage strength, the cover portion 112 and 113 may include a dummy electrode not participating in capacitance formation.

The thickness of the cover portion 112 and 113 may not be limited to any particular example. However, to easily implement miniaturization and high capacitance of the multilayer electronic component, the thickness tc of the cover portion 112 and 113 may be 15 μm or less.

The average thickness tc of the cover portions 112 and 113 may indicate the size in the first direction, and may be an average value of the sizes in the first direction of the cover portions 112 and 113 measured at five points at an equal distance in an upper portion and a lower portion of the capacitance formation portion Ac.

The margin portions 114 and 115 may be disposed on side surfaces of the capacitance formation portion Ac.

The margin portions 114 and 115 may include a first margin portion 114 disposed on one surface of the capacitance formation portion Ac in the third direction and a second margin portion 115 disposed on the other surface of the capacitance formation portion Ac in the third direction.

The margin portions 114 and 115 may indicate a region between two ends of the first and second internal electrodes 121 and 122 and a boundary surface of the body 110 in a cross-section in the width-thickness (W-T) direction of the body 110 as illustrated in FIG. 3.

The margin portions 114 and 115 may basically prevent damages to the internal electrode due to physical or chemical stress.

The margin portions 114 and 115 may be formed by forming an internal electrode by applying a conductive paste other than the region in which the margin portion is to be formed on the ceramic green sheet.

The width of the margin portions 114 and 115 may not be limited to any particular example. However, to easily implement miniaturization and high capacitance of the multilayer electronic component, the average width of the margin portions 114 and 115 may be 15 μm or less.

The average width of the margin portions 114 and 115 may indicate the average size MW1 in the third direction of the region in which the internal electrode is spaced apart from the fifth surface and the average size MW2 in the third direction of the region in which the internal electrode is spaced apart from the sixth surface, and may be an average value of the sizes in the third direction of the margin portions 114 and 115 measured at five points at an equal distance on the side surface of the capacitance formation portion Ac.

Accordingly, in an embodiment, the average sizes MW1 and MW2 in the third direction of the region spaced apart from the fifth and sixth surfaces of the internal electrodes 121 and 122 may be 15 μm or less, respectively.

The external electrodes 131 and 132 may be disposed on the third surface 3 and the fourth surface 4 of the body 110.

The external electrodes 131 and 132 may be disposed on the third and fourth surfaces 3 and 4 of the body 110, respectively, and may include first and second external electrodes 131 and 132 connected to the first and second internal electrodes 121 and 122, respectively.

In the embodiment, the multilayer electronic component 100 may have two external electrodes 131 and 132, but the number of the external electrodes 131 and 132 or the shape thereof may be varied depending on the shape of the internal electrodes 121 and 122 or other purposes.

The external electrodes 131 and 132 may be formed using any material having electrical conductivity, such as a metal, and the specific material may be determined by considering electrical properties and structural stability, and may further have a multilayer structure.

For example, the external electrodes 131 and 132 may include electrode layers 131a and 132a disposed on the body 110 and plating layers 131b and 132b formed on the electrode layers 131a and 132a.

For a more specific example of the electrode layers 131a and 132a, the electrode layers 131a and 132a may be fired electrodes including a conductive metal and glass, or resin electrodes including conductive metal and resin.

Also, in the electrode layers 131a and 132a, fired electrodes and resin electrodes may be formed in order on the body. Also, the electrode layers 131a and 132a may be formed by transferring a sheet including conductive metal to the body, or may be formed by transferring a sheet including conductive metal to the fired electrode.

A material having excellent electrical conductivity may be used as the conductive metal included in the electrode layers 131a and 132a, and is not limited to any particular example. For example, the conductive metal may be one or more of nickel (Ni), copper (Cu), and alloys thereof.

The plating layers 131b and 132b improve mounting properties. The types of the plating layers 131b and 132b are not limited to any particular example, and may be plating layers including one or more of Ni, Sn, Pd, and alloys thereof, and may be formed as a plurality of layers.

For more specific examples of the plating layers 131b and 132b, the plating layers 131b and 132b may be Ni plating layers or Sn plating layers, and Ni plating layers and Sn plating layers may be formed in order on the electrode layers 131a and 132a, or Sn plating layers, Ni plating layers, and Sn plating layers may be formed in order thereon. Also, the plating layers 131b and 132b may include a plurality of Ni plating layers and/or a plurality of Sn plating layers.

The size of the multilayer electronic component 100 may not be limited to any particular example. For example, the length L of the multilayer electronic component 100 may be 0.4-5.7 mm, the thickness T of the multilayer electronic component 100 may be 0.1-3.2 mm, and the width W of the multilayer electronic component 100 may be 0.2-5.0 mm.

Here, the length L of the multilayer electronic component 100 may indicate the maximum size in the second direction of the multilayer electronic component 100, the thickness T of the multilayer electronic component 100 may indicate the maximum size in the first direction of the multilayer electronic component 100, and the width W of the multilayer electronic component 100 may indicate the maximum size in the third direction of the multilayer electronic component 100.

According to the aforementioned embodiments, by disposing a crystal phase formed of an oxide including a rare earth element and Si on a surface of the cover portion, reliability of the multilayer electronic component may be improved.

Also, high-temperature reliability of the multilayer electronic component may improve.

The embodiments do not necessarily limit the scope of the embodiments to a specific embodiment form. Instead, modifications, equivalents and replacements included in the disclosed concept and technical scope of this description may be employed.

Throughout the specification, similar reference numerals are used for similar elements.

In the embodiments, the term “embodiment” may not refer to one same embodiment, and may be provided to describe and emphasize different unique features of each embodiment. The above suggested embodiments may be implemented do not exclude the possibilities of combination with features of other embodiments. For example, even though the features described in an embodiment are not described in the other embodiment, the description may be understood as relevant to the other embodiment unless otherwise indicated.

An expression used in the singular encompasses the expression of the plural, unless it has a clearly different meaning in the context.

While the embodiments have been illustrated and described above, it will be configured as apparent to those skilled in the art that modifications and variations could be made without departing from the scope of the present disclosure as defined by the appended claims.

What is claimed is:

1. A multilayer electronic component, comprising:
a body including a capacitance formation portion including a dielectric layer and internal electrodes alternately disposed with the dielectric layer in a first direction, and cover portions disposed in upper and lower portions in the first direction of the capacitance formation portion, respectively, and including first and second surfaces opposing each other in the first direction, third and fourth surfaces connected to the first and second surfaces and connected to each other in a second direction, and fifth and sixth surfaces connected to the first to fourth surfaces and opposing each other in a third direction;
external electrodes disposed on the body,
wherein the cover portion includes one or more crystal phases having an oxide including a rare earth element and Si, and
wherein, when an area ratio occupied by the crystal phase in a central portion of one of the first and second surfaces is defined as S1, and an area ratio occupied by the crystal phase in a central portion of a cross-section in the first and third directions of one of the cover portions is defined as S2, S1>S2 is satisfied, the one of the first and second surfaces being an exterior surface of the one of the cover portions.

2. The multilayer electronic component of claim 1, wherein the rare earth element includes yttrium (Y).

3. The multilayer electronic component of claim 1, wherein the crystal phase includes Y₂Si₂O₇.

4. The multilayer electronic component of claim 1, wherein a ratio of a long axis to a short axis of the crystal phase is 1.5 or more and 60 or less.

5. The multilayer electronic component of claim 1, wherein a length of a short axis of the crystal phase is 0.05 μm or more and 0.5 μm or less, and a length of a long axis of the crystal phase is 0.1 μm or more and 3.0 μm or less.

6. The multilayer electronic component of claim 1, wherein S1 is 5% or more.

7. The multilayer electronic component of claim 1,
wherein S1 is 5% or more and 50% or less, and
wherein S2 is 0% or more and 0.1% or less.

8. The multilayer electronic component of claim 1,
wherein a cross-sectional area of the crystal phase is 1.0 μm² or more, and
wherein the crystal phase is disposed at 0.25/μm² or more and 2.0/μm² or less on the one of the first and second surfaces.

9. The multilayer electronic component of claim 1,
wherein a cross-sectional area of the crystal phase is 1.0 μm² or more,
wherein the crystal phase is disposed at 0.25/μm² or more and 2.0/μm² or less on the first and second surfaces, and
wherein the crystal phase is disposed at 0.01/μm² or less on the cross-section in the first and third directions of the one of the cover portions.

10. The multilayer electronic component of claim 1,
wherein the one of the cover portions includes a plurality of dielectric crystal grains, and
wherein the crystal phase is disposed on the dielectric crystal grains on the one of the first and second surfaces.

11. The multilayer electronic component of claim 1, wherein the one of the cover portions includes one or more of BaTiO₃, (Ba₁₋ₓCaₓ)TiO₃ (0<x<1), Ba(Ti_{1-y}Ca_{y})O₃ (0<y<1), (Ba₁₋ₓCaₓ)(Ti_{1-y}Zr_{y})O₃ (0<x<1, 0<y<1) and Ba(Ti_{1-y}Zr_{y})O₃ (0<y<1) as a main component.

12. The multilayer electronic component of claim 1, wherein the crystal phase does not include Ba and Ti.

13. The multilayer electronic component of claim 1,
wherein the one of the cover portions other than the crystal phase includes Ba, Ti, Mn and Mg, and
wherein the crystal phase does not include Ba and Ti.

14. The multilayer electronic component of claim 1, wherein the one of the cover portions includes one or more of BaTiO₃, (Ba₁₋ₓCaₓ)TiO₃ (0<x<1), Ba(Ti_{1-y}Ca_{y})O₃ (0<y<1), (Ba₁₋ₓCaₓ)(Ti_{1-y}Zr_{y})O₃ (0<x<1, 0<y<1) and Ba(Ti_{1-y}Zr_{y})O₃ (0<y<1) as a main component, and includes 3 moles or more of Y based on 100 moles of Ti.

15. The multilayer electronic component of claim 1, wherein the crystal phase has a rod shape.
